(19) United States
(12) Patent Application Publication
(10) Pub. No.: US 2007/0112713 A1
(43) Pub. Date: May 17, 2007

(54) METHOD AND APPARATUS FOR PROFILING A POTENTIAL OFFENDER OF A CRIMINAL INCIDENT

(75) Inventors: CHRISTOPHER G. SEAMAN, SOUTH JORDAN, UT (US); ADAM L. LINTZ, DRAPER, UT (US); MARK R. STIEGEMEIER, PARK CITY, UT (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/557,819

(22) Filed: Nov. 8, 2006

Related U.S. Application Data
(60) Provisional application No. 60/735,278, filed on Nov. 10, 2005.

(51) Int. Cl. G06N 5/00; G06Q 99/00; G06N 5/02

(52) U.S. Cl. 706/45; 706/50; 705/1

(57) ABSTRACT

A method for profiling a potential offender associated with a criminal incident includes the steps of: creating a criminal case for a criminal incident, wherein the incident is categorized into at least one crime type based upon at least one parameter associated with the incident; receiving, into the criminal case based on the at least one crime type, evidence input data corresponding at least to the at least one parameter and collected physical evidence; and performing, using a processing device, a behavioral analysis based on the at least one crime type and the evidence input data to generate a behavioral profile of a potential offender associated with the incident, which identifies a plurality of behavioral traits of the potential offender.

### CROSS-REFERENCE TO RELATED APPLICATIONS

The present application is related to the following U.S. application commonly owned together with this application by Motorola, Inc.:

Ser. No. 60/735,278, filed Nov. 10, 2005, titled “Method and Apparatus for Profiling Criminal Suspects” by Seaman, et al. (attorney docket no. CM08460G).

### TECHNICAL FIELD

The field of the invention relates to criminal investigations and more particularly to a method and apparatus of generating a behavioral profile identifying behavioral traits and a personality type of a potential offender of a criminal incident and linking the criminal incident to other criminal incidents based on the behavioral profile.

### BACKGROUND

Criminal investigations are typically performed on an ad hoc basis. Upon the discovery of a criminal incident, a case is created for the incident that is to be investigated by one or more investigators who collect evidence associated with the case. If a scene of the crime can be identified, the investigator collects any physical evidence from the scene. Similarly, if a victim or witnesses are available, the investigator typically interviews the victim and witnesses. While collecting physical evidence, the investigator may begin to formulate initial theories as to a potential offender and circumstances surrounding the incident. As interviews with the victim and/or witnesses progress, the investigator may revise these initial theories and/or form additional theories, which are used in an attempt to determine facts about the incident and to identify potential offenders (also interchangeably referred to herein as suspects or criminal suspects) associated with the incident.

In an effort to foster a broader exchange of facts, the Federal Bureau of Investigation (FBI) has promulgated the Violent Criminal Apprehension Program (ViCAP) as an investigative tool (database) that collects information about the signature aspects/traits of homicides and similar patterns of modus operandi. ViCAP has proven somewhat effective in providing a standardized database for homicide. However, it requires an investigator and/or other personnel to populate a relatively long form (i.e., 32 pages plus a 2-page addendum), which is often not completed because of its length. In addition, the ViCAP database fails to incorporate intangible aspects of the criminal investigative process such as, for instance, the complexities of the investigative process, the different approaches required by different types of crimes, and the relationship between behavioral or personality traits of potential offenders and various criminal incidents.

Accordingly, a need exists for a method and apparatus that provides an automated way of relating criminal incidents based at least in part upon intangible aspects of the criminal investigative process such as behavioral profiles of potential offenders associated with the criminal incidents, which are generated by the system. It is further desirable that the method and apparatus provide training to a user based upon data input by the user in response to prompts from the system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates is a block diagram of a system in accordance with an embodiment of the present invention.

FIG. 2 is a flow diagram illustrating a method in accordance with an embodiment of the present invention.

FIG. 3 illustrates an exemplary information resource structure for a case stored in a persistent storage medium included in the system of FIG. 1.

FIG. 4 illustrates an exemplary information flow diagram that may be used by the system of FIG. 1 to generate behavioral profiles and link criminal cases based on the generated profiles.

FIG. 5 illustrates an exemplary checklist window that may be presented to a user of the system of FIG. 1.

FIG. 6 illustrates an exemplary victim interview window that may be presented to a user of the system of FIG. 1.

FIG. 7 illustrates an exemplary suspect typology window that may be presented to a user of the system of FIG. 1.

FIG. 8 illustrates the use of a behavioral analysis to link a criminal case to one or more other stored criminal cases in accordance with an embodiment of the invention.

FIG. 9 illustrates is a block diagram of a system in accordance with another embodiment of the invention.

### DETAILED DESCRIPTION

Before describing in detail embodiments that are in accordance with the present invention, it should be observed that the embodiments reside primarily in combinations of method steps and apparatus components related to a method and apparatus for profiling criminal suspects. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for profiling criminal suspects described herein. The non-processor circuits may include, but are not limited to, user input devices. As such, these functions may be interpreted as steps of a method to perform the profiling of criminal suspects described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device and a magnetic storage device. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

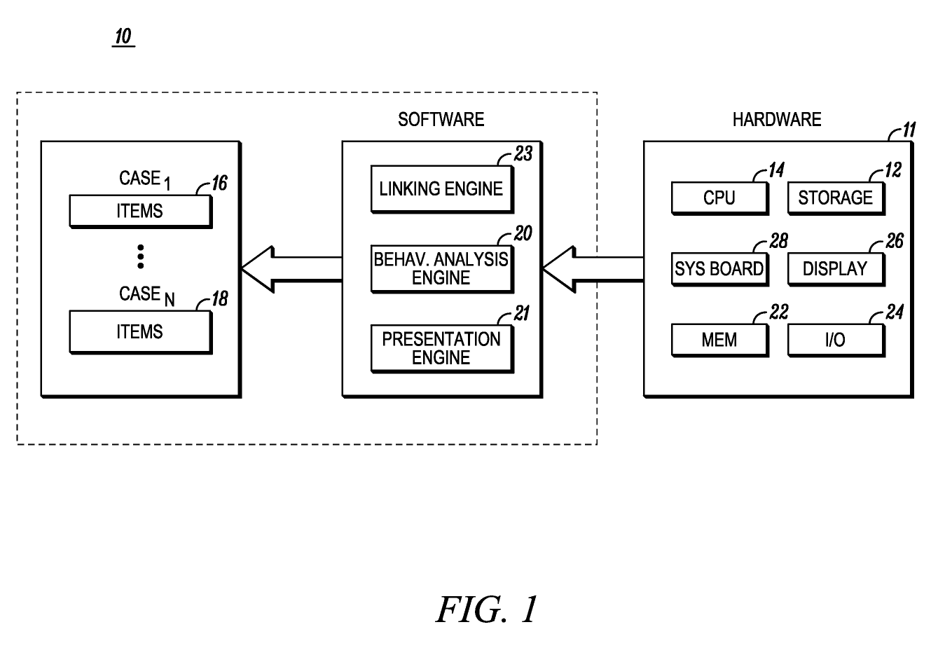

Generally speaking, pursuant to the various embodiments, a method and apparatus (e.g., a system 10 shown in FIG. 1 and described in detail below) is provided for profiling criminal suspects. In general, system 10 is designed to help investigators analyze and link related cases based upon automated behavioral profiles (including personality profiles) of criminal suspects of various crimes, wherein the automated behavior profiles are generated by system 10 using a behavioral analysis engine executed in the system. Existing case management systems capture data, but do not generate such automated behavioral profiles of criminal suspects let alone use these profiles to analyze and link criminal cases. Moreover, commercially available systems in use today rely only upon physical evidence (e.g., DNA matching, fingerprint analysis, weapon analysis, etc.) to link cases. By contrast, system 10 can quantify a suspect's personality and behavioral traits to tailor the data collection process to more accurately suit a particular type of offender associated with a given crime type, to reflect the collected evidence and to further link one criminal case to other cases accessible by the system.

A given behavioral profile generated by system 10 can, for instance, be used to develop, based on a personality type of a potential offender, targeted: interrogation techniques for a suspect; witness and/or victim interviews; and investigative and prosecutive strategies for a user of the system. The system 10 can also be used to compare the behavior profile to existing behavior profiles accessible by system 10 to automatically suggest possible links to other cases to assist in the further collection of evidence and identification of suspects. For example, system 10 can determine overall personality attributes of a possible offender, and provide a very specific set of interview questions that are most likely to evoke a confession from a suspect. Also upon determining likely personality traits of the possible offender, system 10 can further search previous cases where those traits are exhibited and present such cases to an investigative officer for review to identify a possible offender common to multiple crimes.

Therefore, system 10 can be viewed as an expert system designed to guide and educate users such as law enforcement officers and other criminal investigators on various investigative protocols. As an expert system, the user is guided through a number of steps while being educated at the same time. Some of the steps include the completion of a checklist or document presented by the system 10, wherein in one implementation each document comprises (as a way of educating the user) detailed information about why each question in the document is being asked and what the answer might mean about the offender, evidence or state of the victim. Moreover, system 10 may be applied to virtually any criminal situation or crime type (e.g., sexual assault, homicide, kidnapping, financial crimes, etc.).

Referring now to the drawings and in particular FIG. 1, a block diagram of a system in accordance with an illustrated embodiment of the invention is shown and generally indicated at 10. System 10 includes hardware 11 that may be implemented using a suitable computer having one or more interfaces (e.g., a user interface, a wireless or wired connection to various persistent storage mediums such as databases, etc.) for obtaining information and data regarding one or more criminal cases, and a processing device (such as one or more of the processing devices listed above) coupled to the interface(s) and performing methods in accordance with the teachings herein. For example, hardware 11 may comprise a personal computer (PC) or some suitable work station, a laptop, etc.

In this embodiment, hardware 11 comprises: a storage medium 12 that includes some amount of persistent storage such as a hard disk or Read Only Memory, which provides for permanent or semi-permanent storage of items (i.e., a non-volatile storage medium that at least outlasts system reboot); a memory 22, e.g., a volatile memory such as a Random Access Memory, storing executable code in accordance with embodiments of the invention; a central processing unit (CPU) 14 executing the stored code and using, e.g., one or more of the information in storage 12, information input by a user of the system, information retrieved from remote persistent storage (such as various databases), etc. to perform method steps in accordance with embodiments herein for profiling criminal suspects. System 10 further includes conventional elements of one or more user input/output devices 24 such as a keyboard, scanner, tablet, printers, network cards to connect to a network, etc. and one or more displays 26 to enter and display information relevant to operation of the system 10, and a system board 28. Elements 24, 26 and 28 and their functionality are well known in the art and will, therefore, not be discussed here further for the sake of brevity. In one exemplary implementation, system 10 is a laptop of a field law enforcement officer or a work station located at a law enforcement agency.

Further illustrated by reference to FIG. 10 are various applications stored in storage 12 and/or memory 22 and being executed by the CPU. These applications (e.g., executable code) include a behavioral analysis engine 20 for generating a behavioral profile of a possible offender associated with a given criminal incident, where an incident is characterized by an event occurring during a finite instance of time, which can be categorized into one or more crime types based on one or more parameters associated with the incident. The applications further include a linking engine 23 to link or identify cases that are sufficiently similar (or related) to a given criminal case under investigation and a presentation engine to determine a format for presenting data, training, etc. to a user of system 10.

Also accessible to system 10 is a set of criminal cases or case files/folders, e.g., Case₁ 16 to Case_{N} 18, that are organized based on a given data structure or format specification or requirements for the system, and that are stored in any combination of storage 12, memory 22 and remote storage (such as one or more law enforcement databases). Each case file is created for a different criminal incident and includes a number of items or information related to the case. For example Case₁ 16 may be an unsolved case that is currently being investigated by one or more law enforcement personnel, and the other case files may correspond to additional solved or unsolved cases stored elsewhere in system 10 or networked to system 10 from remote systems, wherein system 10 compares these other cases to Case, using the linking engine 23, in accordance with the teachings herein.

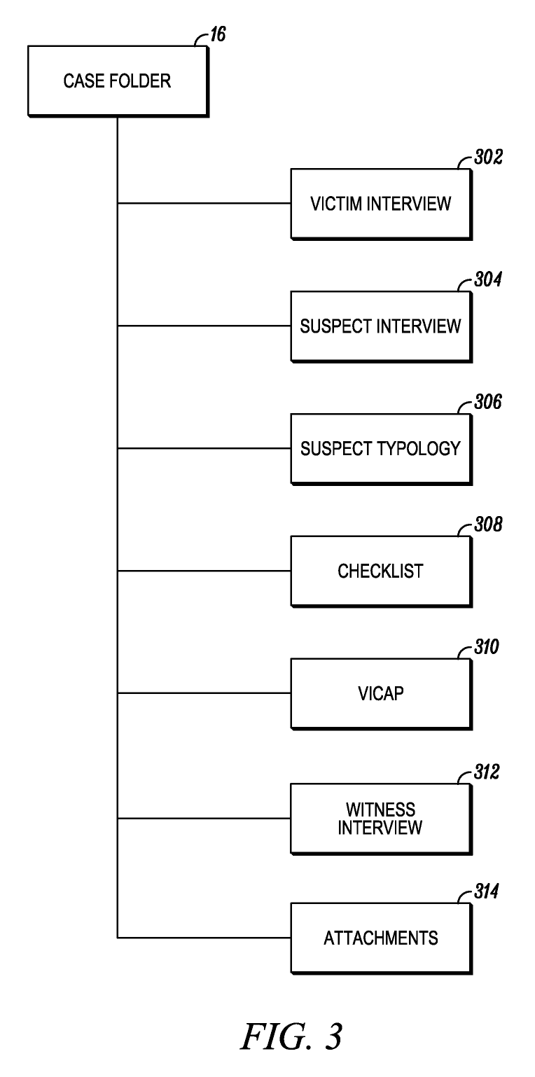

A given criminal incident can be associated with, for instance, none, one or multiple victims, witnesses and suspects or possible offenders, a crime scene, physical evidence etc., wherein such information is stored in the case folder. Accordingly, FIG. 3 illustrates an exemplary information resource structure for a case folder (e.g., Case₁ 16). Those of ordinary skill in the art will realize that this resource structure can be modified based on system and storage design requirements, specifications and/or constraints and that illustrated therein are functional representations of how such data may be organized. Moreover, the case folder contains at least one of the “folders” described below and may contain none, one or multiple such folders in any combination depending on the circumstances surrounding the incident.

Turning again to FIG. 3, a case folder can include a victim interview folder 302, a suspect interview folder 304, a suspect topology folder 306, a checklist folder 308, a ViCAP folder 310, a witness folder 312 and various attachments 314. Although the term “folder” is used, it should be appreciated that this term does not imply any particular data format or structure but is used merely for ease of reference. Moreover, all of the information stored in the case folder is collectively referred to herein as “evidence input data” that is input into system 10 and correspondingly input via one or more interfaces (as described above) into a case file created by the system.

Turning now to the contents of each folder, the victim interview folder 302 stores evidence input data corresponding to information collected during one or more victim interviews and may further contain an analysis or filter (e.g., victim typology) of this information. The suspect interview folder 304 stores evidence input data corresponding to information collected during one or more suspect interviews. The suspect typology folder 306 stores results of a behavioral analysis performed by the behavioral analysis engine 20. The checklist folder 308 stores evidence input data corresponding to one or more checklists completed by an investigator of the case. The ViCAP folder 310 stores evidence input data corresponding to information collected for entry or inclusion in the ViCAP database. The witness interview folder 312 stores evidence input data corresponding to information collected during one or more witness interviews. The attachments folder 314 can store a variety of other evidence input data including, but not limited to, images of crime scene photographs and other physical evidence, DNA and/or fingerprint evidence, information relating to the parameter(s) use to categorize the criminal incident into one or more crime types, etc. Moreover, there may be a set of the above folders associated with each crime type into which the incident was categorized and there may be other folders not shown that are utilized based on, for instance, the agency conducting the investigation.

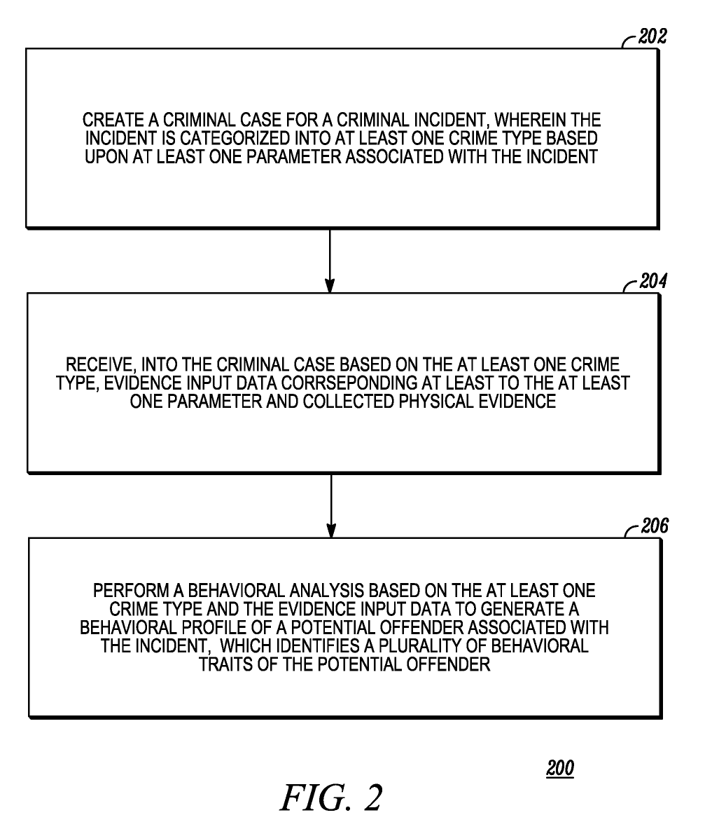

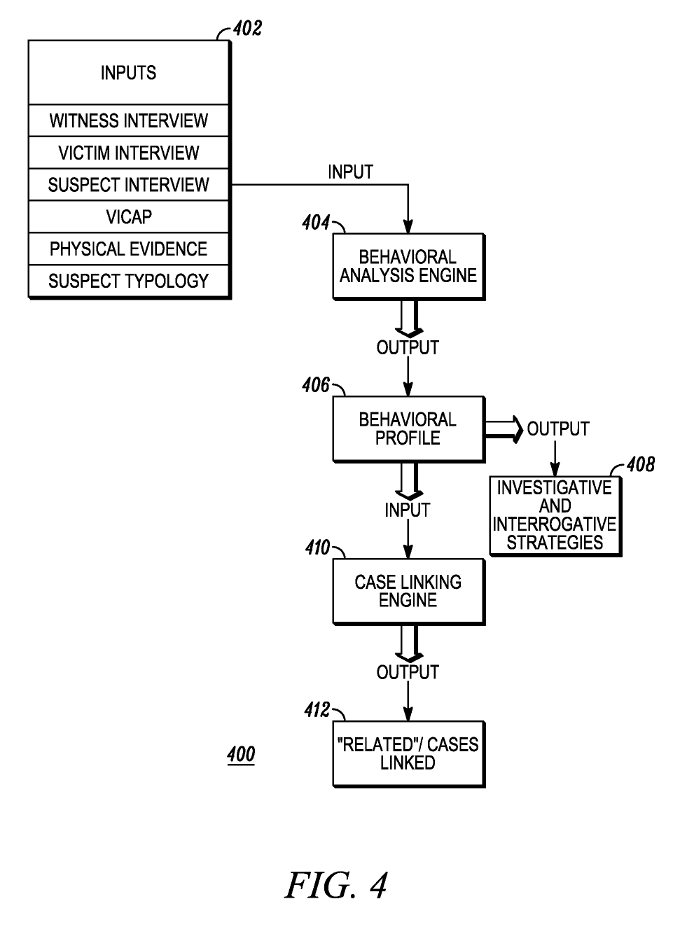

Referring now to FIG. 2 and FIG. 4, a method 200 and an information flow 400 through system 10 for profiling criminal suspects and linking related cases is shown and illustrated. In accordance with method 200, system 10 (at steps 202 and 204) creates a criminal case (e.g., case folder 16) for an identified criminal incident, wherein the incident is categorized into one or more crime types based on one or more parameters associated with the incident and receives into the criminal case folder (based on or as categorized by crime type) evidence input data corresponding to the parameters, collected physical evidence, etc. The one or more parameters may include, but are not limited to: the fact that an offender uses of a weapon during the commission of a crime (which may indicate a desire for high levels of power and/or domination); the fact that an incident occurs during the afternoon (which may indicate an unemployed offender or an offender having “odd-houred” employment); “posing” or “positioning” of a victim's body (which may indicate sadistic qualities and ego); a body “dump” location differing from a location in which the offense against the victim took place; a surprise attack versus coercion, etc.

These evidence data inputs (402), based on any combination of witness interviews, victim interviews, suspect interviews, ViCAP data, physical evidence, suspect typology, etc., serve as input into the behavioral analysis engine (step 404), which performs (step 206) the behavioral analysis based on and using this input data to generate the behavioral profile (406) of a potential offender. The behavioral profile, in one embodiment, comprises a two-dimensional personality matrix (e.g., as shown in Table 3) having a set of behavioral traits on a first axis (from which are identified a plurality of behavioral traits of the potential offender) and a set of personality types on a second axis (from which are identified one or more personality types of the potential offender). The behavioral profile is input (step 410) into the case linking engine 23, which compares the criminal case under investigation to a plurality of stored criminal cases based on the behavioral profile of the potential offender. If no related cases are output, this result can still indicate valuable information to an investigator, for instance that the crime possibly involves a first-time offender. However, in many instances the case linking engine selects at least one of the stored criminal cases (step 412), which satisfies at least one case linking parameter (e.g., one or more thresholds or a boundary function), wherein the selected criminal cases comprise a set of related criminal cases, and the case linking engine may further rank the set of related criminal cases to indicate a degree of similarity of each related criminal case to the criminal case under investigation.

System 10 may further use the behavioral profile generated by the behavioral analysis engine to develop an investigative strategy for the case that may include, for instance, a victim interview comprising a list of relevant questions to ask a witness to the crime and/or a suspect interview strategy comprising a list of interview questions to ask a suspect of the crime. Moreover, answers input by the investigator to one or more of the questions in these interviews may be further used as a basis for training and instructing the investigator during the investigative process. An investigative strategy may comprise various other aspects such as, for instance, how to locate the offender. For example, where evidence input data suggests that the potential offender is unemployed, system 10 would therefore lead the investigator away from seeking out a place of employment of the offender.

In one embodiment, a user of system 10 (for instance a field officer or investigator sent to a crime scene) uses the system to categorize a criminal incident into one or more crime types and to create and store a corresponding case folder for the incident. For example, upon signing onto the system 10, an investigator may be presented with an applications window via the display device 26 to assist the user in categorizing the criminal incident. In one implementation, the investigator is presented with a number of choices from a crime list file to allow the investigator to select and activate (using an enter button on the input/output devices 24) a crime identification (ID) number associated with one of a plurality of listed crime types. While categorizing the incident, the investigator may further be prompted to enter evidence input data corresponding to the parameter(s) associated with the incident for storing on the system for further use in performing a behavioral analysis using engine 20. For purposes of the present description and the continued discussion, let's say that the investigator categorized the criminal incident as a sexual assault crime type. However, it should be apparent that the teachings herein are not limited to the sexual assault crime type but are easily applied to any crime type into which an incident can be categorized. Therefore just as with the sexual assault crime type, instructions, questionnaires, etc., can be designed based on other crime types.

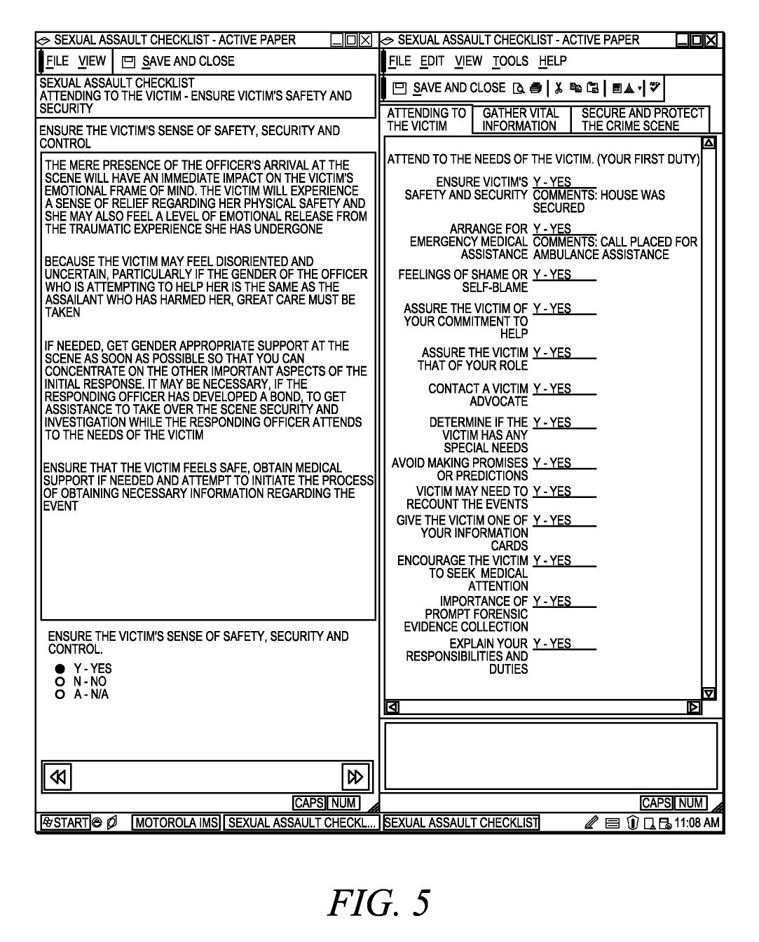

In response, the presentation engine 21 may present the investigator with a number of initial checklists and questionnaires. In this regard, the presentation engine 21 may retrieve a sequence of checklists from checklist files, interactive instructions from an interactive instructions file and questionnaires from a questionnaire file, and display the checklists, instructions and questionnaires within a respective interactive window on the display 26. Examples of such instructions, checklists and questionnaires displayed in an interactive applications window of the system are illustrated by reference to FIGS. 5-7 (described below in further detail). For example, one of the questionnaires may be a ViCAP form, and other questionnaires may include a victim interview questionnaire if a victim is available for questioning, a witness interview questionnaire if a witness is available for questioning and a suspect interview questionnaire if a suspect is available for questioning, wherein the evidence collected using these forms/questionnaires are stored in the case folder.

Alternatively, the investigator may cause the system 10 to provide paper copies of the checklists, instructions and/or questionnaires for use at the crime scene by the investigator to interview any victim(s), witness(es) and suspect(s), wherein the resulting answers are entered into system 10 at a later time through the input/output devices 24. Table 1 below is an exemplary checklist for investigating a sexual assault crime, and Table 2 is an exemplary suspect interview questionnaire for investigating a sexual assault crime (with both questionnaires shown with exemplary responses).

Since the information being received into and analyzed in system 100 can be quite large, in one implementation system 10 uses a number of filters to collect and receive evidence input data to generate a behavioral profile of a potential offender associated with the incident under investigation. In general, the behavioral profile identifies a plurality of behavior traits of a potential offender and may further identify at least one personality type of the potential offender based on the identified behavioral traits. Information regarding personality characteristics of a potential offender is useful in identifying suspects and in linking the case under investigation to previous and future criminal incidents since in most cases a person's personality stays relatively constant over time. For the example of the crime of sexual assault, the filters may include: 1) victimology; 2) geographical based upon initial contact site; 3) geographical based upon crime scene; 4) geographical based upon a disposal site; 5) physical assault; 6) sexual assault; 7) modus operandi versus signature; 8) organized versus disorganized; 9) offender risk level and 10) suspect information, which are used to collect information from any of a number of sources. For instance, information about the offender may be collected from the victim, from witnesses' statements, from a ViCAP form and from the investigator. If the victim is deceased, then information about the victim may be obtained and entered into the system 10 from family and friends, from physical evidence or from witnesses.

The first filter, victimology, refers to the study of the victim to obtain behavioral cues of a potential offender. In this regard, the study of the victim involves the context of the victim and the crime type. In general, victimology may be one of the most difficult for the investigator to execute in an appropriate manner (especially manually and/or by persons who are not criminal profiling experts), but is nonetheless one of the most important aspects of a criminal investigation in gaining insight into behavioral and personality traits of an offender. In order to accomplish this task, the system 10 provides a training and prompting function (e.g., through an interactive questionnaire implemented via the displays 26 and that is referred to herein as the “learn mode” of system 10) that operates to remove variables involving the personality of the investigator from the profiling results and to provide a level of interactive training for an investigator.

This interactive training is not provided in known systems but can prove very useful in many scenarios. For example, consider a small regional area that does not have dedicated personnel having experience in homicide investigations. An investigator in this region could use system 10 for assistance and training in conducting a homicide investigation within forty-eight hours of the crime, which is considered by most seasoned investigators as the most critical time for collecting evidence that will lead to the apprehension of an offender. Such training and instruction may be based on answers input by the investigator in response to questions on the questionnaires (witness, victim, suspect) and may include, but is not limited to, one or more of the following: presenting to the user an explanation for asking a particular during an interview; determining and presenting to the user at least one implied characteristic of the potential offender based on the answers input by the user; and determining and presenting to the user at least one suggestion for interacting with a victim associated with the incident and at least one corresponding anticipated reaction of the victim when the user is interacting with the victim.

Accordingly in order to prepare the investigator, system 10 may provide the investigator with a checklist window that identifies a number of steps that the investigator should follow for a particular type of crime. FIG. 5 illustrates an exemplary interactive window that presents a checklist (right window pane) for the crime of sexual assault. The checklist provides a context for the investigation and ensures conformance with the proper context by requiring that the investigator acknowledge performance of every step by entering an acknowledgement and verification that each step has been performed. The left window pane provides some training for the investigator regarding the purpose of this window and the investigator's interaction with a victim in response to this window.

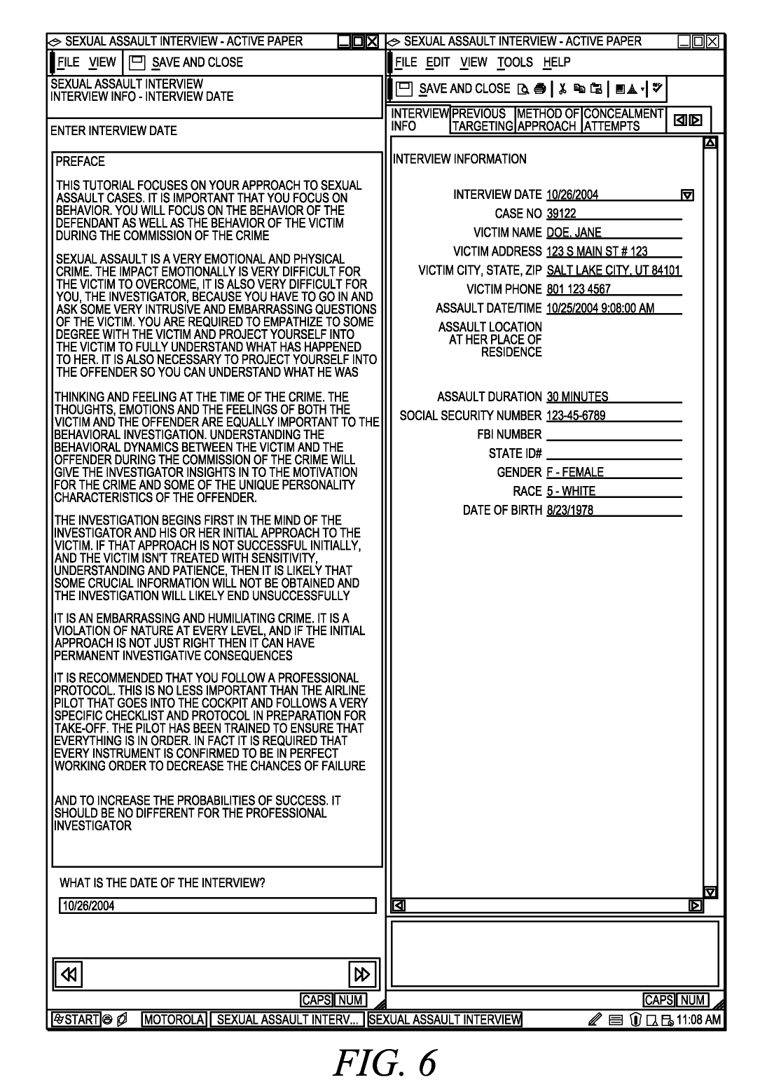

The system 10 may then enter an “investigator learn mode” and prompt the investigator with a victim interaction instruction window to place the investigator into a proper frame of mind for interviewing a sexual assault victim. FIG. 6 (left side) is an example of an instruction window provided by the system 10 and that may be presented to the investigator in order to accomplish this step. In order to ensure that this step has been performed, the investigator is required to answer a preliminary set of questions (FIG. 6, top right) in order to progress to the next step of victimology. Once the investigator has been placed into the proper state of mind, the investigator may be prompted with a detailed set of questions (e.g., from Table 1 below) provided through a set of interactive windows on the display 26. Implicit within the questions is the recognition that everything that a criminal does (or that we do), e.g., the behavioral traits, is an indication of our personality and that anything that a criminal does (or that we do) is instilled with personality traits. In effect, the questions presented in the windows associated with Table 2 outline the scope of victimology in terms directed to identifying a personality of the offender.

Another filter may be geographical based upon initial contact site. The initial contact site may be where the offender initially made contact with the victim. The determination of the initial contact may be made based upon the interview with the victim or from witnesses. The next filter may be geographic based upon crime scene. It should be noted that the crime in this case in this example is sexual assault. If the victim were abducted before the sexual assault, the abduction would be a separate crime and would not define the site of the crime. In this case, the scene of the sexual assault would be the crime scene. Again, the scene of the crime may be obtained from the victim or witnesses. The next filter is geographical based upon disposal site. In this case, if the assault was to occur in a car and the victim was released elsewhere, then the point of release would be the disposal site.

The next filter is physical assault. In this case, a physical assault may be a separate crime that is imposed on an otherwise compliant victim. Evidence of physical assault may be physical or from witnesses if the victim is not available. The next filter is sexual assault. In this case, sexual assault refers to the physical aspect of the crime. Evidence of sexual assault may be physical or from witnesses if the victim is not available. The next filter is modus operandi versus signature. Modus operandi in this case may refer to what the offender did in the normal course of the crime versus what the offender felt necessary to complete the crime. For example, if the offender used rope in the crime, the use of the rope would indicate modus operandi whereas the particular type of rope or knots used would be the signature of the offender.

The next filter is organized versus disorganized. This refers to how the offender approached the crime. Did the offender bring a weapon or simply use what was available? The next filter is offender risk level. This refers to the relative risk to the offender of being held accountable for the crime such as seizing a victim in a public place or assaulting the victim in a dark and isolated alley. The final exemplary filter is suspect information. Suspect information may relate to the perceivable (observed) aspects of the offender (e.g., what kind of car did the offender drive?, how did he act?, etc.).

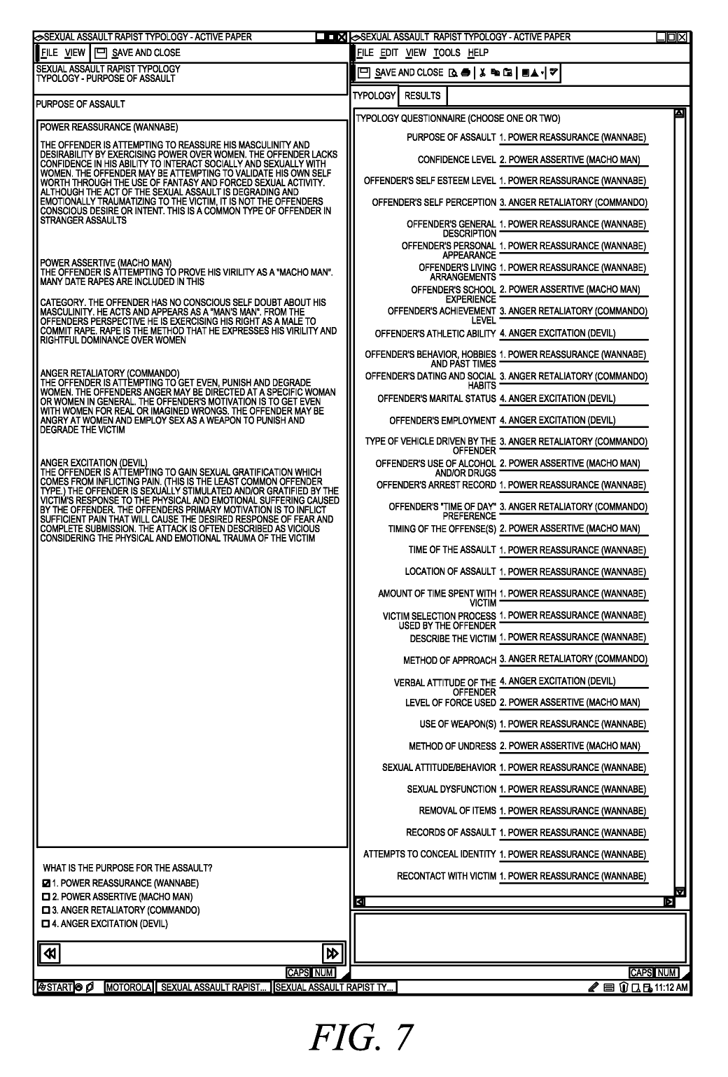

Once the information is collected from the crime scene and from the victim and witnesses, the system 10 may present the investigator with a series of windows that elicit the impressions about the personality of the offender from the investigator. Table 3 provides a completed questionnaire (termed a personality matrix) that has been prepared for an example offender. FIG. 7 provides a window that summarizes the information in Table 3 and provides definitions of four personality types associated with the sexual assault crime type. Table 3 is suspect a typology document that includes a series of multiple choice questions about the crime scene and that attempts to quantify the offender's personality into known personality types. The suspect typology document attempts to capture elements from all ten filters, and infers a personality type based upon the types of actions the offender performs (e.g., the offender's behavioral traits). For the sexual assault profile, the result is a percentage ranking in each one of four separate personality types: 1) power reassurance (wannabe); 2) power assertive (macho man); 3) anger retaliatory (commando) and 4) anger excitation (devil). Other personality types may be identified based upon the type of offense. Using the inferred personality types from the questionnaires, the investigator can generate a description of the type of offender they are seeking.

In one exemplary embodiment, for example, the behavioral analysis engine 20 sequentially applies the ten filters to the information that is collected from the crime scene, from the victim and witnesses and from the investigator, a filter processor 23 may sequentially apply the ten filters to the collected information. Each of the ten filters collects attributes regarding a particular personality trait. Each of the attributes may be assigned a numerical value and totalized for each of the four personality types. At least some of the attributes may be weighted with respect to other attributes. It should be noted in this regard, that the analysis of the data about the personality of the offender provides a ranking (by percentage) of the offender according to the four different personality types. In effect, the ranking provides a personality signature of the offender that corresponds to a coordinate in four dimensional space (i.e. x,y,z,t).

Once the investigator collects and provides the information discussed above, the case linking engine 23 uses the personality signature to find related cases. In this regard, case linking engine 23 (conceptually) plots the personality percentages generated from the suspect topology for each case being compared to the case under investigation in a multidimensional coordinate system constructed within the database. The percentages are plotted using a dimension for each personality type (x,y,z,t). It should be noted in this regard that the personality signature conforms to the equation x+y+z+t<100. If all of the questions in the typology are answered, then the equation is the same, except that the total (x+y+z+t) equals 100 instead of being less than 100. This allows the engine 23 to account for vagueness in the data.

The engine 23 may form a boundary function (e.g., a sphere/circle) around the personality signature of the offender from the reference crime (i.e., the “base case”) that defines the boundary of “likeness” or similarity to the base case. The function is divided into 100 parts, with a value of 0 given to the boundary, and a value of 100 given to the base case (reference crime). This allows a user to obtain a relative “likeness” value. The boundary function could be any function, including a non-spherical function that accounts for the natural tendency for personality types to be related. For example, wannabe and devil are quite different, and not likely to exist together, whereas commando and devil would be a more prevalent combination. The engine 23 may produce a list of cases that are ordered by their relative “likeness” to the base case based for instance on where they fall on the plot relative to the boundary function. This list may then be presented to the investigator to review and determine which cases are worthy of further investigation and comparison.

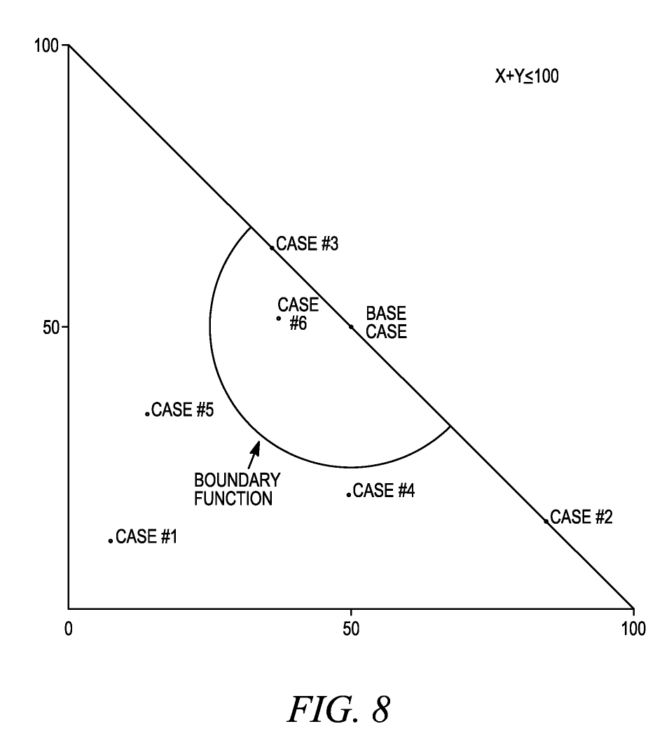

In order to understand the concept of the personality signature coordinate system, a simplified version of the personality signature may be shown in two-dimensional space (assuming 2 personality types (x,y)) (FIG. 8). The concepts are the same as more dimensions (personality types) are added. In FIG. 8, each case is plotted on an x-y graph where each axis extends from 0 to 100. A circle with a predetermined radius is drawn around the base case. Any plotted point that lies within the circle (e.g., a Case #3 and a Case #6) shown in FIG. 8 is considered to be a related case. The engine 23 identifies related cases based upon thresholds within the behavioral profile. In this regard, the engine 23 identifies cases based upon the respective personality signatures and assigns each case a relative rating based upon a distance of the case from the base point (base case), with the outer boundary of the circle having a value of 0 and the base case having a value of 100. FIG. 8 shows an example of this particular scenario. In this example, the base case is approximately 50% X and 50% Y. The engine 23 considers Cases #3 and #6 to be related as they are within the boundary function around the base case. The distance of each case from the base case, as opposed to the boundary function, provides the relative ranking. As may be noted in this regard, case #6 has a higher ranking than case #3. Cases #1, #2, #4 and #5 would not be identified and presented to the investigator as related cases as they fall outside of the boundary.

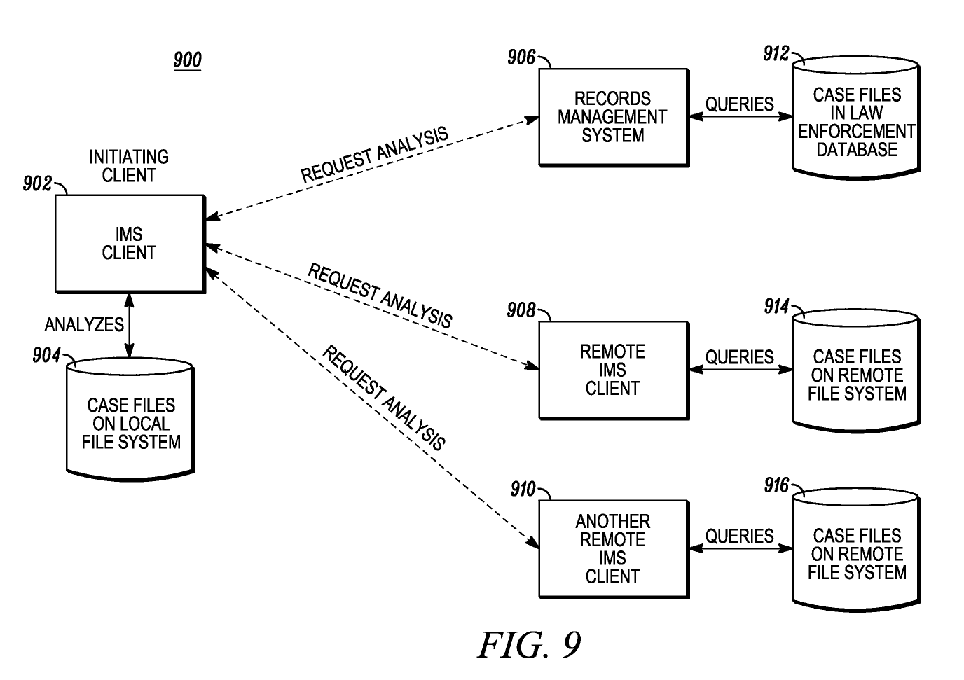

It may be noted that the system 10 of FIG. 1 may be extended to any level of system complexity, as shown in FIG. 9. As shown in FIG. 1, the system 10 may be used as a local system only. Alternatively, the system 10 can be implemented as a peer-to-peer network, where an investigator may query any system 10 in his immediate vicinity. In addition, the system 10 may be implemented as a distributed and service-oriented architecture or extended to provide support for separate (or combined) state and federal efforts. Where implemented as a system 900, as shown in FIG. 9, a national or regional server 906 may be provided that includes a national or regional database 912. One or more clients 902, 908, 910 may access the server 906 through the Internet or wide area network (WAN). Each client (e.g., 902) may provide the functionality of the system 10 described above by maintaining its own database 904 of cases and provide access to its own database and to remote databases (e.g., 914, 916) of other clients, again through the Internet, a WAN or a local area network (LAN). Thus, cases may be profiled through the local client 902 based upon information retrieved from the local database 904, from the server database 912 or remote databases 914, 916.

A specific embodiment of a method for profiling criminal suspects has been described for the purpose of illustrating the manner in which the invention is made and used. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

[image]

[image]

[image]

[image]

[image]

[image]

[image]

[image]

[image]

[image]

[image]

[image]

[image]

[image]

[image]

[image]

[image]

[image]

[image]

[image]

TABLE 3

| | 2. Power | 3. Power | 4. Anger | 5. Anger |
|---|---|---|---|---|
| | Reassurance | Assertive | Retaliatory | Excitation |
| | (WANNABE) | (MACHO MAN) | (COMMANDO) | (DEVIL) |
| | 2.5% | 2.5% | 15.0% | 77.5% |
| | Interviewing | Interviewing | Interviewing | Interviewing |
| | Tips | Tips | Tips | Tips |
| Purpose | To reassure his | To prove his virility | To get even, punish | To gain sexual |
| | masculinity by | as a “macho man”. | and degrade women. | gratification witch |
| | exercising power | Many date rapes are | Anger may be | comes from inflicting |
| | over women | included in this | directed at a specific | pain. (Least common |
| | | category | woman or women in | offender) |
| | | | general. | |
| Confidence Level | Lacks confidence to | Has a high level of | No inhibitions of | Absolute self- |
| | develop and | confidence | inopportunity and | confidence |
| | maintain social and | | impulse are present. | |
| | sexual relationships | | Lacks concern | |
| Self-Esteem Level | Low self-esteem | High self-esteem; no | Moderate self- | High self-esteem; |
| | throughout various | doubts about his | esteem; blames | proud of his |
| | aspects of his life | masculinity, and | others for his actions | sophistication of |
| | | “man's man” | and problems | criminal acts; etc. |
| Self-Perception | Sees himself as a | A macho image which | Comfortable with | Masterful. |
| | looser | is important to | himself, he isn't the | |
| | | portray to others | problem, women are. | |
| General | Gentle quite and | Self-centered; does | Acquaintances may | Generally a white |
| Description | passive | not like to be under | report a “dark-side”; | male; outgoing well |
| | | control of or work for | has an expiosive | liked high I.Q., |
| | | others | personality, acts | compulsive. No |
| | | | impulsively, which | history of mental |
| | | | may have resulted in | health care |
| | | | arrests for assault. | |
| Personal | Takes little pride in | Takes pride in | Takes moderate | Takes pride |
| Appearance | personal appearance | personal appearance, | amount of pride in | reflective of his self- |
| | | wants to look good to | appearance, but does | perception. |
| | | others. Works to | not base it on | |
| | | portray a “macho” | society's | |
| | | image | expectations. | |
| Living | May live alone or | May live with a wife | May live with a wife | May live with a wife |
| Arrangements | with a parent. | or girlfriend. | or girlfriend. In a | or girlfriend. |
| | | | disruptive | |
| | | | relationship | |
| School Experience | May have been | Capable of high | High school diploma | Some college |
| | referred to a | school and | | education |
| | councilor for | trade/technical. | | |
| | inability or | | | |
| | underachievement | | | |
| Achievement Level | Underachiever; does | Moderate; capable | Restricted by | High achiever in |
| | not try to do better, | and confident in | outbursts and | selected areas of |
| | even in areas where | areas of interest | impulsiveness. | interest. |
| | he may not be | | | |
| | capable | | | |
| Athletic Ability | Non-athletic | Good athletic ability | Lacks discipline and | Depends on interest |
| | | Exercises regularly, is | patience to maintain | |
| | | possibly a body- | significant condition. | |
| | | builder. | Gets bored without | |
| | | | quick results | |
| Behavior/Hobbies/ | Solitary activity such | Exercises, hangs out | Short-term hobbies | Bondage |
| Pastime | as reading, TV, etc | at bars or discos. | and interests which | pornography, |
| | | History of conflict | provide quick results | outdoorsman, |
| | | with women because | and satisfaction. | survivalists, may own |
| | | of selfish behavior. | Minimal to no use of | a large dog. |
| | | | pornography | (Shepherd or |
| | | | | Doberman) |
| Dating/Social | If he dates, he may | Possibly married | Superficial | Will not act out |
| Habits | date girls that are | more than once; it is | relationships, no | against a girlfriend |
| | significantly younger | difficult for a woman | close friends. | who is typically not |
| | | to stay with him. | Capable of | under his total |
| | | | socializing, but | control. |
| | | | prefers to be alone. | |
| Marriage Status | Single | Probably Single | Possibly married | Can be “happily” |
| | | | more than once, may | married. Wife is |
| | | | have physical conflict | typically under his |
| | | | with his wife and | control. |
| | | | domestic calls to | |
| | | | police. | |
| Employment | Works at a menial | Works at a “macho” | Works at an action | White-collar job or |
| | job with little or no | job; heavy | oriented job. | white-collar criminal. |
| | contact with the | equipment, outdoor | | Would do well in |
| | public; possibly a | work, police, etc. | | military. |
| | night job | | | |
| Type of Vehicle | Unimpressive low | A “macho type” of | Possibly an outdoors | A “family-type” car. |
| | maintenance/upkeep; | car; possibly | type of vehicle. | |
| | possibly excessive | excessive miles. | | |
| | miles | | | |
| Alcohol/Drug Use | May use moderate | Use reflective of | Drinks to release | Does not abuse |
| | amounts to build | “macho” image. | inhibitions; abuses | drugs; might use but |
| | confidence | | alcohol. | does not want to |
| | | | | loose control. |
| Arrest Record | May have prior arrest | May have prior arrest | May have prior arrest | No prior arrest |
| | record for minor | record for assault | record for assault | record. |
| | sexual assault | behavior and sexual | behavior and sexual | |
| | offenses such as | offenses. | offenses. | |
| | peeping, panty | | | |
| | theft, etc. | | | |
| “Time of Day” | Nocturnal | Opportunistic, | Opportunistic. | Selective. |
| Preference | | related to his | | |
| | | perception of safety | | |
| | | and need. | | |
| Timing of the | Every 7 to 15 days; | May be multiple | No set timing; | No pattern; attacks |
| Offense | this cycle may | assaults within same | attacks are | when he desires and |
| | accelerate if | evening. | precipitated by | feels his plan is |
| | unsuccessful | | trigger events in his | foolproof. |
| | attempts have been | | life. | |
| | made. | | | |
| Time of the | Usually late evening | Usually early evening | Anytime, day or | Selective, |
| Assault | to early morning | hours. | night, depending on | premeditated, |
| | hours. | | the motivational | variable. |
| | | | factor of anger. | |
| Location of Assault | Within walking | Away from residence | Opportunistic. | Takes victim to a |
| | distance of | and employment; | | secluded area. |
| | residence, | feels comfortable | | |
| | employment or | leaving his | | |
| | places he visits. | immediate area. | | |
| Amount of Time | Generally a short | Generally a short | Generally a short | Hours to days (or |
| Spent With Victim | period of time; if | period of time, but | duration for sexual | longer); keeps |
| | victim is compliant, | extended if he | and physical assault | victims over a period |
| | may spend more | performs repeated | | of time. |
| | time during which he | sexual assaults. | | |
| | will act out | | | |
| | fantasies. | | | |
| Selection Process | Normally made in | Often meets the | Selects symbolic | Victims are |
| used by the | advance of the | victim the same night | victims who | strangers, victims of |
| Offender | assault through | as the assault in a | represent women he | opportunity, |
| | surveillance or | bar, disco, etc. | wants to “get even | although fit certain |
| | peeping. May have | Victims are victims of | with.” Time and | criteria to fulfill |
| | many selected | opportunity, not pre- | selection of victim | desires and fantasies. |
| | targets and if one is | selected. | generally not | |
| | unavailable will | | premeditated. | |
| | choose another. | | | |
| Describe the | Normally the victim | Normally the victim | Normally the victim | Age of the victim |
| victim | is within 3-4 years of | is within 3-4 years of | is in his own age | does not matter. |
| | his own age. | his own age. | range or older, but | |
| | | | not elderly. | |
| Method of | Surprise attack. | Con, with a high | Blitz: attacks | Con |
| Approach | | level of confidence. | spontaneously and | |
| | | | out of anger; | |
| | | | frenzied attack, | |
| | | | impulsive action. | |
| Verbal Attitude of | Unselfish. | Selfish and | Selfish, demeaning, | Selfish. Voice is non- |
| the Offender | Fantasizes that the | demanding. | commanding | emotional and |
| | victim wants him; he | | | instructional. |
| | may instruct her to | | | |
| | tell him so. | | | |
| Level of Force | Minimal; does not | Moderate; does not | Excessive; beyond | Brutal; often results |
| Used | wish to harm the | need to harm, but | that which is | in death. Bindings, |
| | victim. | will use enough force | necessary to control | torture, and devices |
| | | to get what he | the victim. | render victim |
| | | wants. | | psychologically and |
| | | | | physically helpless. |
| Use of Weapons | Relies on the threat | May use hand or fist; | Typically uses | Favorite weapon is a |
| | of weapons, but | usually will not have | weapon of | knife. |
| | often does not have | weapon unless | opportunity because | |
| | one. May use a | customarily carries | attacks are | |
| | weapon | one. | spontaneous, not | |
| | unintentionally. | | pre-planned. | |
| Method of Undress | Usually will have the | Tears off victim's | Rips or tears off | Cuts off victim's |
| | victim undress | clothing. | victim's clothing. | clothing |
| | herself and may | | | |
| | have her undress | | | |
| | him. | | | |
| Sexual | Unselfish. | Selfish, with no | Selfish, getting even | Selfish, premeditated |
| Attitude/Behavior | | concern for the | with women for real | and practiced |
| | | victim. | or imagined wrongs | mentally before it is |
| | | | Uses sex as a weapon | attempted. Uses |
| | | | to punish and | instruments and |
| | | | degrade. Anger is | devices, practices |
| | | | the key component. | bondage, and may |
| | | | | tape record sexual |
| | | | | acts. Fixated on anal |
| | | | | sex. |
| Sexual Dysfunction | May experience | May experience | May experience | May experience |
| | erectile insufficiency | retarded ejaculation | retarded ejaculation | retarded ejaculation |
| | and premature | due to hostility and | due to hostility and | due to hostility and |
| | ejaculation. | anger. | anger. | anger. |
| Removal of Items | May take a souvenir | May takes clothes, | Not generally. May | May take souvenirs |
| | to use to relive the | leaving victim in a | leave victim and | and will maintain |
| | event. | partial or full state of | belongings in final | items in privacy and |
| | | undress to delay | assault state; may | concealment. |
| | | ability to report the | take items for | |
| | | assault. | monetary value. | |
| Records of Assault | May keep records in | Not typical. | Not typical. | Yes, depending on |
| | a diary, chart, or | | | offender's |
| | computer. | | | preference, |
| | | | | maturity, experience |
| | | | | or practicalities |
| | | | | (camera, tpes, |
| | | | | video, sketches, |
| | | | | writings) |
| Attempts to | Unsophisticated, but | Not typical, lack of | Unsophisticated at | Sophisticated. |
| Conceal Identity | makes effort. May | significant concern. | best. | |
| | take advantage of | | | |
| | darkness or facial | | | |
| | covering on self or | | | |
| | victim. | | | |
| Recontact with | May recontact to | Unlikely, victim is | Unlikely. | None. |
| Victim | relive the fantasy, | emotionally | | |
| | apologize, or return | discarded. | | |
| | after an unsuccessful | | | |
| | attempt. | | | |

What is claimed is:

1. A method for profiling a potential offender associated with a criminal incident, the method comprising the steps of:
creating a criminal case for a criminal incident, wherein the incident is categorized into at least one crime type based upon at least one parameter associated with the incident;
receiving, into the criminal case based on the at least one crime type, evidence input data corresponding at least to the at least one parameter and collected physical evidence; and
performing, using a processing device, a behavioral analysis based on the at least one crime type and the evidence input data to generate a behavioral profile of a potential offender associated with the incident, which identifies a plurality of behavioral traits of the potential offender.

2. The method of claim 1, wherein the behavioral profile further identifies at least one personality type of the potential offender based on the identified plurality of behavioral traits of the potential offender.

3. The method of claim 2, wherein the behavioral profile comprises a two dimensional personality matrix having a set of behavioral traits on a first axis from which the plurality of behavioral traits of the potential offender are identified and a set of personality types on a second axis from which the at least one personality type of the potential offender is identified.

4. The method of claim 1 further comprising the step of:
comparing, using the processing device, the criminal case to a plurality of stored criminal cases based on the behavioral profile of the potential offender.

5. The method of claim 4, further comprising the step of:
selecting, using the processing device, at least one of the stored criminal cases, which satisfies at least one case linking parameter, wherein the selected criminal cases comprise a set of related criminal cases.

6. The method of claim 5 further comprising the step of:
ranking, using the processing device, the set of related criminal cases to indicate a degree of similarity of each related criminal case to the criminal case.

7. The method of claim 1, wherein the evidence input data further corresponds to at least one of:
information collected during a witness interview;
information collected during a victim interview;
information collected during a suspect interview; and
information collected for entry into a Violent Criminal Apprehension Program (ViCAP) database.

8. The method of claim 1 further comprising the step of generating, using the processing device, an investigative strategy for the criminal case based on the behavioral analysis.

9. The method of claim 1 further comprising the step of generating, using the processing device, at least one of a victim interview strategy and a suspect interview strategy based on the behavioral analysis.

10. The method of claim 9, wherein:
the victim interview strategy comprises a first list of questions to ask a victim associated with the incident; and
the suspect interview strategy comprises a second list of questions to ask a suspect associated with the incident.

11. The method of claim 10 further comprising the step of providing, using the processing device, training for a user based on answers input by the user to questions from at least one of the first and the second list of questions.

12. The method of claim 11, wherein the training comprising at least one of:
presenting to the user an explanation for providing a question on the first or second list of questions;
determining and presenting to the user at least one implied characteristic of the potential offender based on the answers input by the user; and
determining and presenting to the user at least one suggestion for interacting with a victim associated with the incident and at least one corresponding anticipated reaction of the victim when the user is interacting with the victim.

13. The method of claim 1, further comprising the step of storing the criminal case in a law enforcement persistent storage device.

14. An apparatus for profiling a potential offender associated with a criminal incident comprising:
an interface evidence input data corresponding to a criminal incident that is categorized into at least one crime type based upon at least one parameter associated with the incident and further receiving, wherein the evidence input data corresponding at least to the at least one parameter and collected physical evidence; and
a processing device coupled to the interface, the processing device, creating a criminal case for the criminal incident that includes the evidence input data;
performing a behavioral analysis based on the at least one crime type and the evidence input data to generate a behavioral profile of a potential offender associated with the incident, which identifies a plurality of behavioral traits of the potential offender;
comparing the criminal case to a plurality of stored criminal cases based on the behavioral profile of the potential offender; and
selecting at least one of the stored criminal cases, which satisfies at least one case linking parameter, wherein the selected criminal cases comprise a set of related criminal cases.

15. The apparatus of claim 14 further comprising at least one law enforcement persistent storage device coupled to the processing device and comprising the plurality of stored criminal cases.

16. A computer-readable storage element having computer readable code stored thereon for programming a computer to perform a method for profiling a potential offender associated with a criminal incident, the method comprising the steps of:
creating a criminal case for a criminal incident, wherein the incident is categorized into at least one crime type based upon at least one parameter associated with the incident;
receiving, into the criminal case based on the at least one crime type, evidence input data corresponding at least to the at least one parameter and collected physical evidence; and
performing a behavioral analysis based on the at least one crime type and the evidence input data to generate a behavioral profile of a potential offender associated with the incident, which identifies a plurality of behavioral traits of the potential offender.

17. The computer-readable storage element of claim 16, wherein the method further comprises the steps of;
comparing the criminal case to a plurality of stored criminal cases based on the behavioral profile of the potential offender; and
selecting at least one of the stored criminal cases, which satisfies at least one case linking parameter, wherein the selected criminal cases comprise a set of related criminal cases.

18. The computer-readable storage element of claim 16, wherein the computer readable storage medium comprises at least one of a hard disk, a CD-ROM, an optical storage device and a magnetic storage device.
